(19) United States
(12) Patent Application Publication
(10) Pub. No.: US 2013/0194208 A1
(43) Pub. Date: Aug. 1, 2013

(54) INFORMATION TERMINAL DEVICE, METHOD OF CONTROLLING INFORMATION TERMINAL DEVICE, AND PROGRAM

(71) Applicant: Panasonic Corporation, Osaka (JP)

(72) Inventors: Ryota MIYANAKA, Osaka (JP); Seiji KUBO, Osaka (JP)

(73) Assignee: PANASONIC CORPORATION, Osaka (JP)

(21) Appl. No.: 13/689,491

(22) Filed: Nov. 29, 2012

Related U.S. Application Data
(63) Continuation of application No. PCT/JP2012/003562, filed on May 30, 2012.

(30) Foreign Application Priority Data
Jan. 30, 2012 (JP) 2012-016650

(51) Int. Cl. G06F 3/041

(52) U.S. Cl. CPC G06F 3/041
USPC 345/173

(57) ABSTRACT

An information terminal device according to the present disclosure includes: a plurality of sensor units configured to detect a finger for inputting operation to at least the information terminal device; a holding hand detection unit configured to detect a holding hand position that is a position of a holding hand for holding the information terminal device; and a control unit configured to select, based on the holding hand position detected by the holding hand detection unit, at least one sensor unit which detects the finger from among the sensor units.

### CROSS REFERENCE TO RELATED APPLICATION

This is a continuation application of PCT Patent Application No. PCT/JP2012/003562 filed on May 30, 2012, designating the United States of America, which is based on and claims priority of Japanese Patent Application No. 2012-016650 filed on Jan. 30, 2012. The entire disclosures of the above-identified applications, including the specifications, drawings and claims are incorporated herein by reference in their entirety.

### FIELD

The present disclosure relates to information terminal devices, control methods of the information terminal devices, and programs, and particularly relates to an information terminal device which detects an object, such as a finger, for inputting operation, a control method of the information terminal device, and a program.

### BACKGROUND

In recent years, mobile information terminals such as smart phones and tablet terminals are used commonly. Such mobile information terminals can be operated by, for example, touch operation and gesture operation which have been gathering attention as user intuitive interfaces (operation methods). Here, an example of the gesture operation includes: recognizing an operation intended by the user by detecting (i) spatial position coordinates and (ii) motion of an object (hereinafter also referred to as target for detection), namely hands or fingers, for inputting operation; and controlling the mobile information terminal.

In order to achieve the gesture operation, it is required to detect the spatial position coordinates of the object (target for detection) for inputting operation with high accuracy. As a technique to detect the spatial position coordinates of the target with high accuracy, a technique is available by which the spatial position coordinates of the target are detected based on differential time which occurs in transmitting and receiving an ultrasound wave or infrared light (see Patent Literature (PTL) 1 and PTL 2, for example).

### CITATION LIST

### Patent Literature

[PTL 1] Japanese Unexamined Patent Application Publication No. 2006-127342

[PTL 2] Japanese Unexamined Patent Application Publication No. 61-067121

### SUMMARY

### Technical Problem

However, in the above conventional technique, a problem is not taken into consideration that the spatial position coordinates of the target cannot be detected in some cases.

The present disclosure has been conceived in view of the above problem, and provides an information terminal device and the like by which the spatial position coordinates of the target can be detected regardless of the position of a holder.

### Solution to Problem

Therefore, the information terminal device according to an aspect of the present disclosure is an information terminal device comprising: a plurality of sensor units configured to detect an object for inputting operation to at least the information terminal device; a held position detection unit configured to detect a held position that is a position of a holder for holding the information terminal device; and a control unit configured to select, based on the held position detected by the held position detection unit, at least one sensor unit which detects the object from among the sensor units.

### Advantageous Effects

With the present disclosure, the information terminal device and the like can be implemented by which the spatial position coordinates of the target can be detected regardless of the position of the holder.

### BRIEF DESCRIPTION OF DRAWINGS

These and other objects, advantages and features of the disclosure will become apparent from the following description thereof taken in conjunction with the accompanying drawings that illustrate a specific non-limiting embodiment of the present disclosure.

FIG. 1 illustrates an example of external appearance of an information terminal device according to Embodiment 1.

FIG. 2 is a block diagram illustrating an example of configuration of the information terminal device according to Embodiment 1.

FIG. 3A is a block diagram illustrating an example of configuration of a first sensor unit according to Embodiment 1.

FIG. 3B is a block diagram illustrating an example of configuration of a second sensor unit according to Embodiment 1.

FIG. 4A illustrates an example where the information terminal device according to Embodiment 1 is used.

FIG. 4B illustrates an example where the information terminal device according to Embodiment 1 is used. FIG. 5 is a flowchart for illustrating an example of processing performed by the information terminal device according to Embodiment 1.

FIG. 6 illustrates another example of external appearance of the information terminal device according to Embodiment 1.

FIG. 7 illustrates an example of external appearance of an information terminal device according to Embodiment 2.

FIG. 8 is a block diagram illustrating an example of configuration of the information terminal device according to Embodiment 2.

FIG. 9 is a flowchart for illustrating an example of processing performed by the information terminal device according to Embodiment 2.

FIG. 10 illustrates an example of a method of detecting a holding hand using a plurality of sensor units, performed by a holding hand detection unit in Embodiment 2.

FIG. 11 illustrates an example of the method of detecting a holding hand using a plurality of sensor unit, performed by the holding hand detection unit in Embodiment 2.

FIG. 12 illustrates an example where the information terminal device according to the present disclosure is used.

### DESCRIPTION OF EMBODIMENTS

### [Underlying Knowledge Forming Basis of the Present Disclosure]

The inventors have found that the following problem is caused in the techniques disclosed in PTL 1 and PTL 2 which are recited in “Background” above.

In PTL 1, a technique is described by which the accuracy in position detection is improved when performing positional coordinate detection using an ultrasound wave sensor, through correcting the change in sound speed caused by temperature change without using a temperature sensor. PTL 2 describes a technique by which resolution is improved without increasing the amount of pairs for photon-emitting/receiving when performing position detection by utilizing a photoelectric sensing method.

However, the techniques disclosed in PTL 1 and PTL 2 do not take into consideration the problem that the spatial position coordinates of the target cannot be detected in some cases. Such a problem is caused because an ultrasound wave emitted by an ultrasound wave transmitter or infrared light emitted by an LED is blocked by a holder. The holder is for holding the mobile information terminal, such as a holding hand for grasping the mobile information terminal or a putting hand arm put on the information terminal device when the user uses the information terminal device on a table or the like.

Especially, users of mobile information terminals, such as smart phones or tablet terminals, often use such mobile information terminals with grasping them. Therefore, the holding hand for grasping the mobile information terminal is likely to have an influence on the spatial position coordinates detection using the ultrasound wave or infrared light, which is the problem.

An aspect of the present disclosure has been conceived in view of the problem, and provides an information terminal device which can detect the spatial position coordinates of the target regardless of the position of the holder.

In order to solve the above problem, the information terminal device according to an aspect of the present disclosure is an information terminal device including: a plurality of sensor units configured to detect an object for inputting operation to at least the information terminal device; a held position detection unit configured to detect a held position that is a position of a holder for holding the information terminal device; and a control unit configured to select, based on the held position detected by the held position detection unit, at least one sensor unit which detects the object from among the sensor units.

With this configuration, the spatial position coordinates of the target can be detected regardless of the position of (i) the holding hand of the user for grasping (holding) the information terminal device or (ii) a putting hand arm of the user put on the information terminal device when the user uses the information terminal on a table or the like. Thus, the user is allowed to use the information terminal device without paying attention to the position of the sensor unit such as the ultrasound wave transmitter or the infrared LED.

Furthermore, in the information terminal device according to another aspect of the present disclosure, for example, the control unit may be configured to select, as the at least one sensor unit, a sensor unit positioned farthest from the held position detected by the held position detection unit.

Furthermore, in the information terminal device according to another aspect of the present disclosure, for example, the control unit may be configured to stop operation of a sensor unit positioned closest to the held position detected by the held position detection unit.

Furthermore, in the information terminal device according to another aspect of the present disclosure, for example, each of the sensor units may include: a transmitter configured to transmit a signal; and a plurality of receivers each configured to receive the signal transmitted from the transmitter.

Here, in the information terminal device according to another aspect of the present disclosure, for example, each of the sensor units may include: a transmitter configured to transmit a signal; and a plurality of receivers each configured to receive the signal transmitted from the transmitter, and the control unit may be configured to select, as the at least one sensor unit, a sensor unit which includes a transmitter positioned farthest from the held position detected by the held position detection unit.

Furthermore, in the information terminal device according to another aspect of the present disclosure, for example, each of the sensor units may include: a transmitter configured to transmit a signal; and a plurality of receivers each configured to receive the signal transmitted from the transmitter, and the control unit may be configured to stop operation of a sensor unit including a transmitter positioned closest to the held position detected by the held position detection unit.

Furthermore, in the information terminal device according to another aspect of the present disclosure, for example, the control unit may be configured to stop, as operation of the sensor unit positioned closest to the held position, operation of only the transmitter positioned closest to the held position detected by the held position detection unit.

Furthermore, in the information terminal device according to another aspect of the present disclosure, for example, the receivers may be common to and shared by each of the sensor units.

Furthermore, the information terminal device according to another aspect of the present disclosure may, for example, further include an object detection unit configured to detect the object, using the at least one sensor unit from among the sensor units selected by the control unit.

Furthermore, in the information terminal device according to another aspect of the present disclosure, for example, the sensor units may be further configured to detect a position that is a position of a holder for holding the information terminal device, and the held position detection unit may be configured to detect the held position using the sensor units.

Furthermore, in the information terminal device according to another aspect of the present disclosure, for example, the held position detection unit may be configured to detect, as the held position, a position of the holder for holding the information terminal device, when a distance to the holder from a display screen of the information terminal device is less than or equal to a threshold.

Furthermore, in order to solve the above problem, a method of controlling the information terminal device according to the present disclosure includes: detecting a held position that is a position of a holder for holding the information terminal device; and selecting, based on the held position detected in the detecting, at least one sensor unit which detects an object from among the sensor units, the object being for inputting operation to at least the information terminal device.

It is to be noted that each of the non-limiting embodiments described below is a specific example of the present disclosure. Numeric values, shapes, materials, constituents, positions and topologies of the constituents, steps, an order of the steps, and the like in the following non-limiting embodiments are an example of the present disclosure, and it should therefore not be construed that the present disclosure is limited by these non-limiting embodiments. Furthermore, out of the constituents in the following non-limiting embodiments, the constituents not stated in the independent claims describing the broadest concept of the present disclosure are described as optional constituents.

A non-limiting embodiment according to the present disclosure is described below with reference to drawings.

### Embodiment 1

Embodiment 1 is described with taking a finger of a user as a target (object for inputting operation) for detecting the spatial position coordinates, as an example. Furthermore, as a holder for holding the information terminal device, (i) a holding hand of the user for grasping (holding) the information terminal device or (ii) a putting hand arm of the user put on the information terminal device when the user uses the information terminal device on a table or the like, is taken as an example. It is to be noted that a putting hand arm is also referred to as a holding hand in some cases, for the convenience in description.

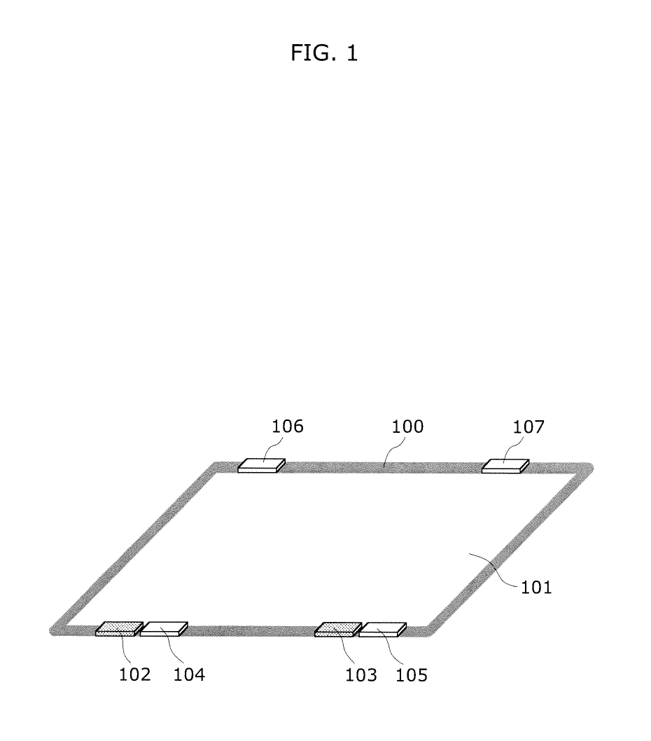

FIG. 1 illustrates an example of external appearance of an information terminal device 100 according to Embodiment 1.

The information terminal device 100 shown in FIG. 1 includes a display unit 101, a first transmitter 102, a second transmitter 103, a first receiver 104, a second receiver 105, a third receiver 106, and a fourth receiver 107.

The information terminal device 100 is a mobile information terminal or a spatial position sensing device which are operable through touch operation and gesture operation, such as a smart phone or a tablet terminal, for example.

The display unit 101 is a liquid crystal display, an organic EL display, or a plasma display, for example. In the present embodiment, description is provided on a premise that the display unit 101 also serves as a touch panel which is operable through a touch of the user. It is to be noted that a panel implemented by a display method other than the above may also be used for the display unit 101.

The first transmitter 102 and the second transmitter 103 are each an example of the transmitter which transmits a signal, and is used to detect the spatial position coordinates of the target. Here, the first transmitter 102 and the second transmitter 103 are each an ultrasound wave transmitter which transmits an ultrasound wave signal, for example.

The first receiver 104 through the fourth receiver 107 are each an example of a plurality of receivers which receives a signal transmitted from the transmitter, and receives the signal transmitted from the first transmitter 102 or the second transmitter 103. For example, the first receiver 104 through the fourth receiver 107 are ultrasound wave receiving sensors and each receives a ultrasound wave signal transmitted from the first transmitter 102 or the second transmitter 103.

Here, description is provided on a method of detecting the spatial position coordinates of a finger of a user that is an object for inputting operation.

A signal (ultrasound wave, for example) transmitted from the first transmitter 102 or the second transmitter 103 is reflected by a finger of the user that is put in space near the display unit 101 for operating the information terminal device 100. The reflected signal (ultrasound wave) is received by the receivers (first receiver 104, second receiver 105, third receiver 106, and fourth receiver 107), and the spatial position coordinates of the finger of the user, that is the target, can be detected in manner of a trilateration, based on the timing the signal is received by each of the receivers. This is, for example, a trilateration using an ultrasonic pulse echo technique which is common as a technique for detecting spatial position coordinates using ultrasound wave.

It is to be noted that, in general, the spatial position coordinates of an object can be detected in manner of a trilateration, if one ultrasound wave transmitter and three ultrasound wave receiving sensors are available. In the present embodiment, one more transmitter and one more receiver are added to the above combination (one transmitter and three receivers) as an example, so that more combinations of the transmitters and the receivers are available for the trilateration. This makes it possible to detect the spatial position coordinates of the finger of the user by switching between the transmitters to use in response to the position of the holding hand.

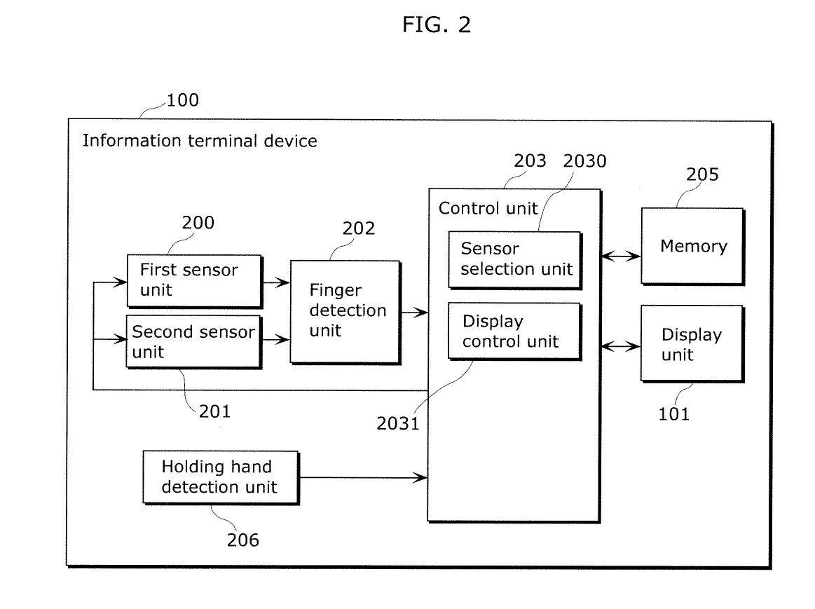

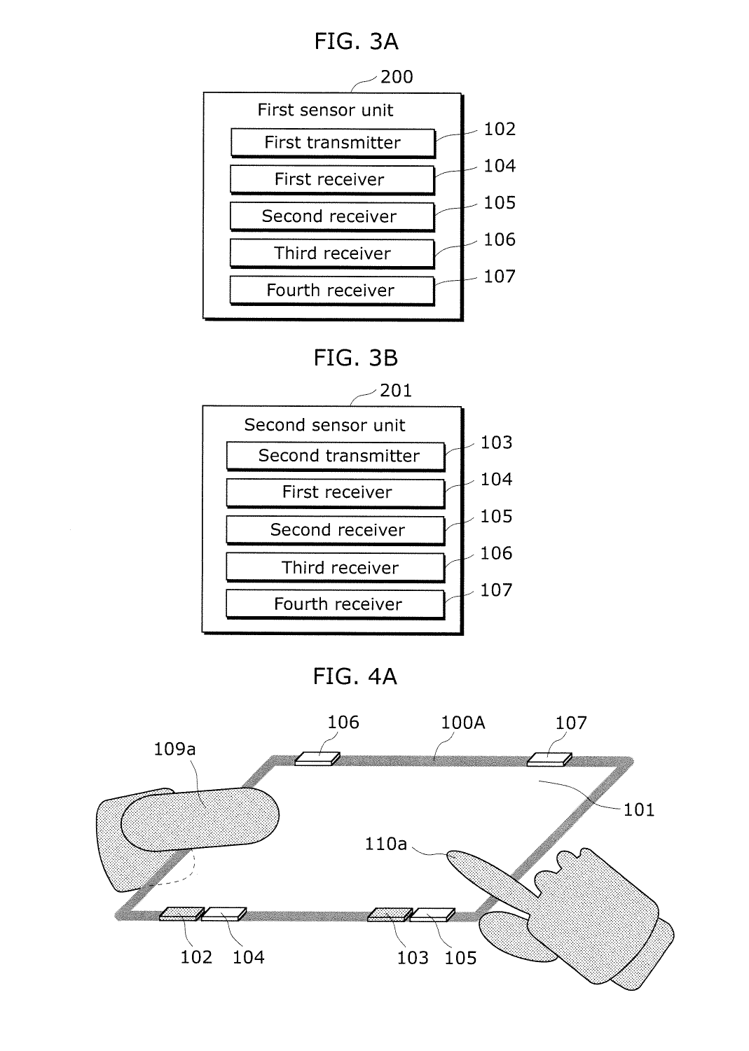

FIG. 2 is a block diagram illustrating an example of detailed configuration of the information terminal device 100 according to Embodiment 1. FIG. 3A is a block diagram illustrating an example of configuration of the first sensor unit according to Embodiment 1. FIG. 3B is a block diagram illustrating an example of configuration of the second sensor unit according to Embodiment 1. It is to be noted that the same constituents as those in FIG. 1 are assigned with the same numerals, and the detailed description is omitted.

As shown in FIG. 2, the information terminal device 100 further includes: a display unit 101; a first sensor unit 200; a second sensor unit 201; a finger detection unit 202; a control unit 203; a memory 205; and a holding hand detection unit 206. Furthermore, the control unit 203 includes a sensor selection unit 2030 and a display control unit 2031 inside.

The first sensor unit 200 and the second sensor unit 201 are each an example of the sensor units, and are used to detect an object (here, finger of user) for inputting operation to at least the information terminal device 100. Here, each of the sensor units includes: a transmitter which transmits a signal; and a plurality of receivers each receives the signal transmitted from the transmitter. In the present embodiment, the receivers are common to and shared by each of the sensor units.

Specifically, as shown in FIG. 3A for example, the first sensor unit 200 is configured with a combination of the first transmitter 102, the first receiver 104, the second receiver 105, the third receiver 106, and the fourth receiver 107. Furthermore, as shown in FIG. 3B for example, the second sensor unit 201 is configured with a combination of the second transmitter 103, the first receiver 104, the second receiver 105, the third receiver 106, and the fourth receiver 107. It is to be noted that hereinafter the first sensor unit 200 and the second sensor unit 201 are also called a plurality of sensor units collectively.

The memory 205 temporarily accumulates the spatial position coordinates of the finger of the user, to recognize the operation by the user performed on the information terminal device 100 based on the change of the spatial position coordinates of the finger of the user, for example. Furthermore, the memory 205 also accumulates data of the control unit 203 as appropriate.

The holding hand detection unit 206 is an example of the held position detection unit, and detects the position of the holding hand (held position) that is a position of the holding hand holding the information terminal device 100.

In the present embodiment, the holding hand detection unit 206 detects the holding hand using the display unit 101 which also serves as the touch panel (includes touch panel portion). That is, the holding hand detection unit 206 detects the position coordinates of the holding hand in contact with the touch panel portion of the display unit 101, using the display unit 101. More specifically, assume that the holding hand detection unit 206 detects a contact at a portion where a screen component (icon or button) is not displayed as shown in FIG. 1, and detects that the contact has continued for longer than or equal to a predetermined time period. The screen component is the peripheral of the display unit 101 and is for operating the information terminal device 100. In such a case, the holding hand detection unit 206 determines that the contact is made by the holding hand, and detects the position coordinates of the holding hand.

It is to be noted that the holding hand detection unit 206 may detect, as the position coordinates of the holding hand (held position), a position of the holder for holding the information terminal device 100, when a distance to the holder from a display screen of the information terminal device 100 is less than or equal to a threshold.

The control unit 203 selects, based on the position coordinates of the holding hand (held position) detected by the holding hand detection unit 206, at least one sensor unit which detects a finger of the user from among the sensor units. For example, the control unit 203 may select a sensor unit which is positioned farthest from the position coordinates of the holding hand (held position) detected by the held position detection unit 206. At this time, for example, the control unit 203 may stop operation of a sensor unit positioned closest to the position coordinates of the holding hand (held position) detected by the holding hand detection unit 206.

In this manner, the control unit 203 selects a sensor unit that tends to be least influenced by the holding hand, based on the position coordinates (held position) of the holding hand detected by the holding hand detection unit 206.

More specifically, the sensor selection unit 2030 selects a sensor unit that tends to be least influenced by the holding hand in the above manner, based on the position coordinates of the holding hand detected by the holding hand detection unit 206. When the display control unit 2031 determines that the change in the spatial position coordinates of the finger of the user obtained by the finger detection unit 202 corresponds to a predetermined operation on the information terminal device 100, the display control unit 2031 controls the display unit 101 or the like to perform an operation assigned with the operation.

The finger detection unit 202 is an example of the object detection unit, and detects the object (here, finger of user) for inputting operation to the information terminal device 100, using the at least one sensor unit from among the sensor units selected by the control unit 203.

Specifically, the finger detection unit 202 detects the finger of the user using the sensor unit selected by the sensor selection unit 2030, and surveys the distance from each of the first receiver 104 though the fourth receiver 107 to the finger of the user, by a distance survey such as an ultrasonic pulse echo technique. Then, the finger detection unit 202 calculates the spatial position coordinates of the finger of the user in manner of the trilateration, based on the distance from each of the first receiver 104 though the fourth receiver 107 to the finger of the user detected by using the selected sensor unit.

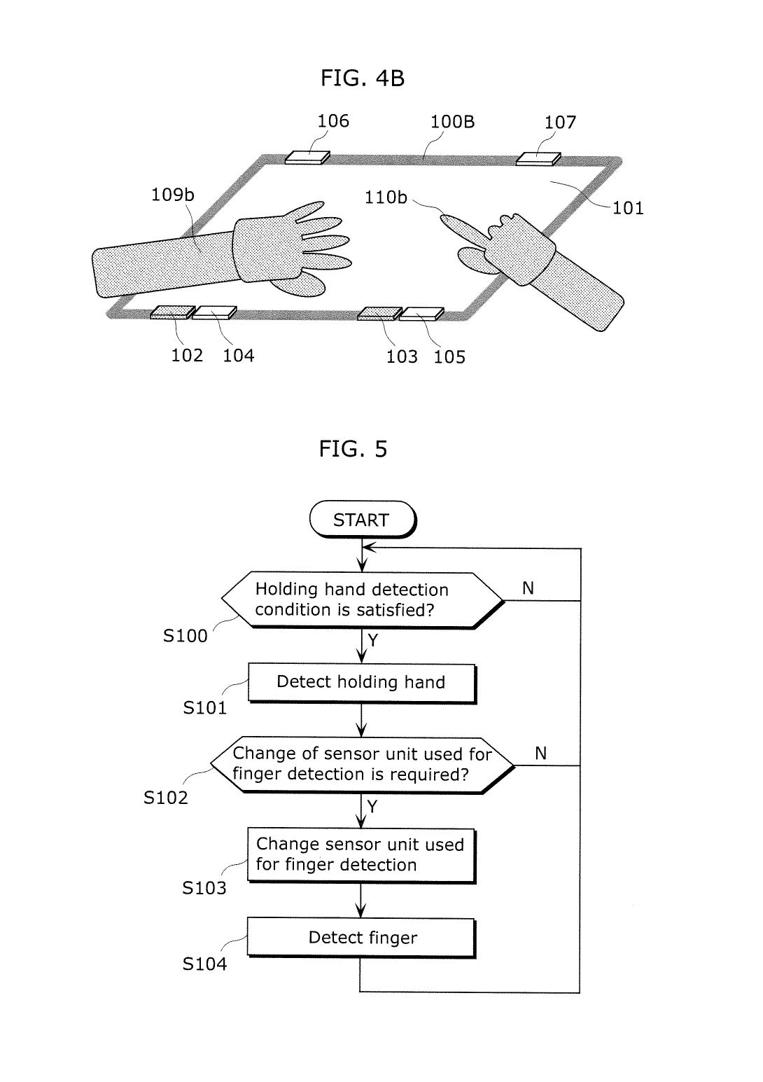

FIG. 4A and FIG. 4B each illustrates an example where the information terminal device 100 according to Embodiment 1 is used. FIG. 4A illustrates an example where a relatively small information terminal device 100A, such as a smart phone, is used. FIG. 4B illustrates an example where a relatively large information terminal device 100B, such as a desktop personal computer, is used.

For example, assume that the finger of the user is detected using the first sensor unit 200. In this case, the first sensor unit 200 cannot transmit and receive a signal since the signal (ultrasound wave, for example) transmitted from the first transmitter 102 is obstructed by a holding hand 109a of the user shown in FIG. 4A or a putting hand arm 109b of the user shown in FIG. 4B. In other words, the first sensor unit 200 fails to detect a finger 110a of the user used for operating the information terminal device 100A or a finger 110b of the user used for operating the information terminal device 100B, in some cases. It is to be noted that whether or not the finger of the user, that is the target, can no longer be detected is determined based on whether or not the signal (ultrasound wave, for example) transmitted from the first transmitter 102 can no longer be received significantly by at least two receivers from among the first receiver 104, the second receiver 105, the third receiver 106, and the fourth receiver 107.

In contrast, assume that the finger of the user is detected using the second sensor unit 201. In this case, since the holding hand 109a of the user shown in FIG. 4A or the putting hand arm 109b of the user shown in FIG. 4B are positioned far from the second transmitter 103, the signal transmitted from the second transmitter 103 tends to be less influenced by them.

Therefore, in the present embodiment, the position coordinates of the holding hand are detected by the holding hand detection unit 206, and a sensor unit appropriate for detecting the spatial position coordinates of the finger of the user is selected by the sensor selection unit 2030.

More specifically, in a case as shown in FIG. 4A or FIG. 4B, the sensor selection unit 2030 selects the second sensor unit 201 which includes the second transmitter 103 that is far from the position coordinates of the holding hand 109a or putting hand arm 109b of the user, as the sensor unit appropriate for detecting the spatial position coordinates of the finger of the user.

Then, the finger detection unit 202 calculates the spatial position coordinates of the finger of the user, based on the distance from each of the receivers to the finger of the user obtained by the second sensor unit 201. When the control unit 203 determines that the change in the spatial position coordinates of the finger of the user obtained in this manner corresponds to the predetermined operation on the information terminal device 100, the control unit 203 controls the display unit 101 or the like to perform an operation assigned with the operation.

Next, processing performed by the information terminal device 100 as configured above is described.

FIG. 5 is a flowchart for illustrating an example of the processing performed by the information terminal device 100 according to Embodiment 1.

First, the information terminal device 100 determines whether or not a holding hand detection condition is satisfied (S100). Here, the holding hand detection condition is a condition not for determining whether or not the holding hand of the user is actually obstructing the detection of the finger of the user, but for determining whether or not a determination should be made on whether or not the holding hand of the user is obstructing the detection of the finger of the user.

For example, assume that the holding hand detection condition is that a certain time period has passed. In this case, for example, it is determined that the holding hand detection condition is satisfied every time the certain time period passes in a state where the power source of the information terminal device 100 is ON, and the processing proceeds to S101. Alternatively, for example, it may be determined that the holding hand detection condition is satisfied when the finger of the user, that is the target, is no longer detected. Alternatively, for example, it may be determined that the holding hand detection condition is satisfied when the user performs new operation on the information terminal device 100 after not performing operation for a certain period of time. Alternatively, it may be determined that the holding hand detection condition is satisfied at timing when the display unit 101 is ON. Alternatively, if the information terminal device 100 includes a sensor, such as a gyro sensor which can detect a motion of the information terminal device 100, it may be determined that the holding hand detection condition is satisfied when it is detected by the sensor that the information terminal device 100 has moved significantly. It is to be noted that the holding hand detection condition is not limited to the above examples and various conditions can be raised. One or a combination of such conditions may be used as the holding hand detection condition.

Next, when it is determined that the holding hand detection condition is satisfied (YES in S100), the holding hand detection unit 206 actually performs holding hand detection (S101). Specifically, the holding hand detection unit 206 detects the position coordinates where the holding hand and the touch panel are in contact, using the display unit 101 which also serves as the touch panel. For example, assume that the holding hand detection unit 206 detects a contact at a portion where a screen component (icon or button) is not displayed, and detects the contact has continued for longer than or equal to a predetermined time period. The screen component is the peripheral of the display unit 101 and is in operating the information terminal device 100. In such a case, the holding hand detection unit 206 determines that the contact is made by the holding hand, and detects the position coordinates of the holding hand. It is to be noted that when the holding hand detection condition is not satisfied (NO in S100), the information terminal device 100 performs processing of S100 again.

Next, the information terminal device 100 determines a sensor unit which tends to be less influenced by the holding hand of the user, and determines whether or not it is required to change the sensor unit used for finger detection (S102).

For example, assume that the position coordinates of the holding hand detected in S101 are close to the transmitter of the sensor unit currently being used. In this case, the control unit 203 determines that the change of the sensor unit used for finger detection is required (YES in S102) and proceeds to S103, since the influence is significant on the detection of the finger of the user that is the target. For example, assume that the position coordinates of the holding hand detected in S101 are far from the transmitter of the sensor unit currently being used. In this case, the control unit 203 determines that the change of the sensor unit used for finger detection is not required (NO in S102) and returns to S100, since the influence is small on the detection of the finger of the user that is the target.

Next, the control unit 203 changes the sensor unit used for actually performing finger detection (S103).

For example, when the processing of S103 is performed in a state where the first sensor unit 200 is used, the control unit 203 (sensor selection unit 2030) performs processing of selecting the sensor unit so that the second sensor unit 201 is used (changing processing).

Next, the finger detection unit 202 actually detects the finger for the user using the selected sensor unit (S104). After the processing of S104 is finished, the processing returns to S100.

In this manner, the information terminal device 100 performs the processing of selecting the sensor unit appropriate for detecting the spatial position coordinates of the finger of the user, as processing of reducing the influence of the holding hand on the signal (ultrasound wave, for example) transmitted from the transmitter, and detects the finger of the user using the selected sensor unit.

As described above, with the information terminal device and the control method of the information terminal device in the present embodiment, the spatial position coordinates of the target can be detected regardless of the position of the holder which holds the information terminal device.

Specifically, with the information terminal device and the control method of the information terminal device in the present embodiment, a different sensor unit (first sensor unit 200 or second sensor unit 201) is selected based on the detection result of (i) the holding hand by which the user grasps (holds) the information terminal device 100 or (ii) the putting hand arm put when the user uses the information terminal device 100 on a table or the like. Then, using the selected sensor unit, the holding hand detection unit 206 detects the finger of the user that is the target for the spatial position coordinate detection. Thus, it is possible to detect the spatial position coordinates of the target, regardless of the position of the holding hand by which the user grasps the terminal or the putting hand arm put when the user uses the information terminal device 100 on a table or the like.

Although the above has described the case where the display unit 101 also serves as the touch panel, the present disclosure is not limited to the above. An example is described below.

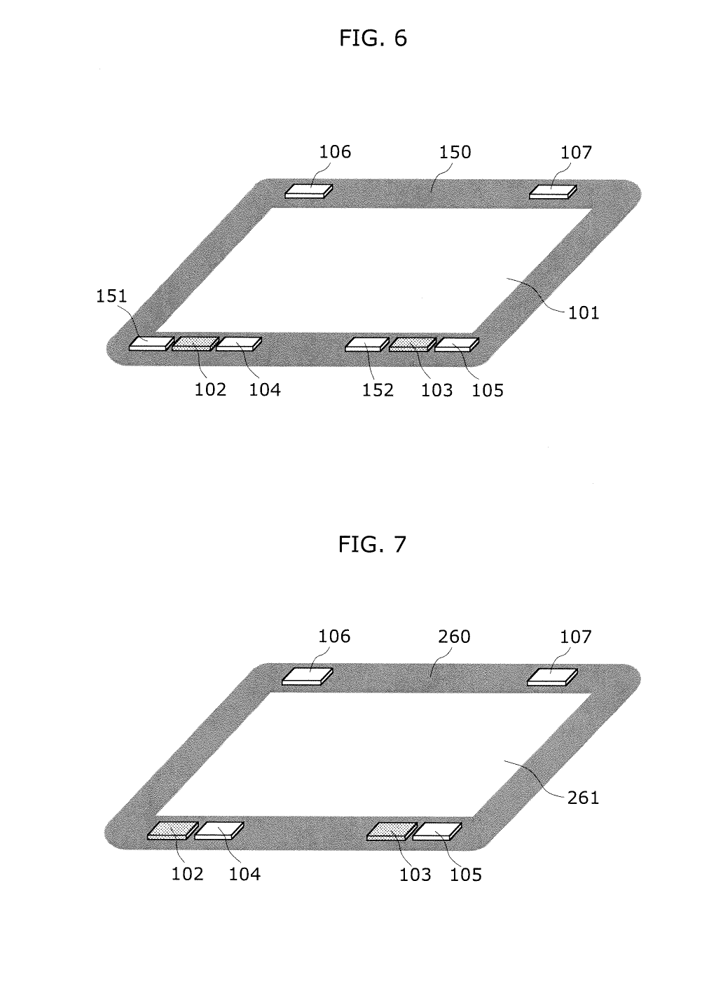

FIG. 6 illustrates another example of external appearance of the information terminal device according to Embodiment 1. It is to be noted that the same constituents as those in FIG. 1 are assigned with the same numerals, and the detailed description is omitted.

An information terminal device 150 shown in FIG. 6 is provided with a pressure sensor 151 near the first transmitter 102, and a pressure sensor 152 near the second transmitter 103. The pressure sensor 151 and the pressure sensor 152 are configured with a piezoelectric sensor or an electrostatic sensor, for example. Thus, the holding hand detection unit 206 can detect the position of the holding hand using the pressure sensor 151 and the pressure sensor 152, even when the display unit 101 does not serve as the touch panel.

It is to be noted that if the holding hand detection unit 206 is a sensor for detecting a holding hand which can detect a contact of a holding hand or presence of a holding hand around the sensor, the present disclosure is not limited to the pressure sensor 151 and the pressure sensor 152 and the touch panel.

Furthermore, although the description has been provided based on the case where the sensor units are two sensor units, namely the first sensor unit 200 and the second sensor unit 201, as an example, the present disclosure is not limited to the above. It is sufficient that the sensor units are greater than or equal to two, and are not specifically limited to be two. Furthermore, when the information terminal device is large and is used with surrounded by a plurality of users, the sensor units may be provided at four sides of the information terminal device.

### Embodiment 2

Although in Embodiment 1 description on the detection of the holding hand (holder for holding information terminal device) has been provided based on a case where a means different from the detection of the finger of the user (object for inputting operation) is used, the present disclosure is not limited to the above. The sensor unit for use in detecting the finger of the user may also be used for detecting the holding hand. Such a case is described in Embodiment 2.

FIG. 7 illustrates an example of external appearance of an information terminal device 260 according to Embodiment 2. It is to be noted that the same constituents as those in FIG. 1 are assigned with the same numerals, and the detailed description is omitted.

The information terminal device 260 shown in FIG. 7 has a different configuration of the display unit from the information terminal device 100 according to Embodiment 1. That is, a display unit 261 is different from the display unit 101 according to Embodiment 1 in that the display unit 261 does not include a touch panel portion.

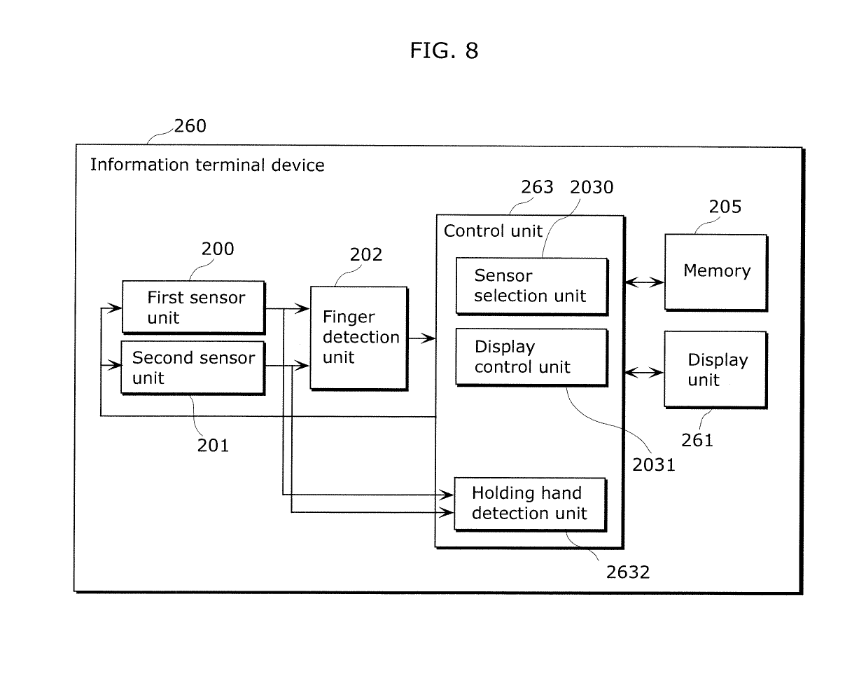

FIG. 8 is a block diagram illustrating an example of configuration of the information terminal device 260 according to Embodiment 2. It is to be noted that the same constituents as those in FIG. 2 are assigned with the same numerals, and the detailed description is omitted.

The information terminal device 260 shown in FIG. 8 has different configurations of the display unit 261 and the control unit 263, from the information terminal device 100 according to Embodiment 1.

Specifically, the control unit 263 further includes a holding hand detection unit 2632 which corresponds to the control unit 203 in Embodiment 1, and the output from the first sensor unit 200 and the second sensor unit 201 are inputted to the holding hand detection unit 2632.

In other words, the first sensor unit 200 and the second sensor unit 201 are each an example of the sensor units, and the sensor units (first sensor unit 200 and second sensor unit 201) are further used to detect a position that is a position of the holding hand holding the information terminal device 100.

Furthermore, the holding hand detection unit 2632 is an example of the held position detection unit, and detects the position of the holding hand (held position) using the sensor units. In the present embodiment, the holding hand detection unit 2632 first detects the position coordinates of the holding hand by alternately switching between the first sensor unit 200 and the second sensor unit 201 in a certain time period. A specific method of detecting the position coordinates of the holding hand is omitted since it is described later.

Then, the sensor selection unit 2030 selects a sensor unit that tends to be least influenced by the holding hand, based on the position coordinates of the holding hand detected by the holding hand detection unit 2632. The sensor selection unit 2030 selects, for example, a sensor unit including a transmitter positioned farthest from the holding hand as described above.

It is to be noted that if no holding hand is detected by alternately switching between the first sensor unit 200 and the second sensor unit 201 in the certain time period, it is indicated that the influence of the holding hand is small on both of the first sensor unit 200 and the second sensor unit 201. Therefore, the sensor selection unit 2030 may select either of the sensor units as the sensor unit used for in detection of a finger of the user.

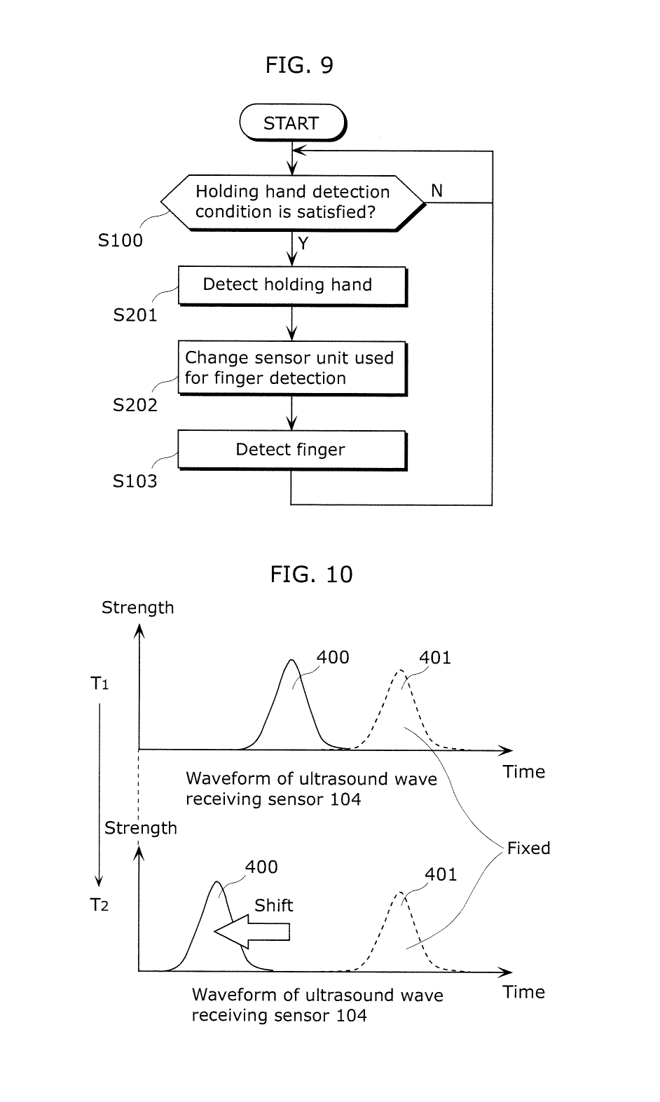

FIG. 9 is a flowchart for illustrating an example of the processing performed by the information terminal device 260 according to Embodiment 2. It is to be noted that the same constituents as those in FIG. 5 are assigned with the same numerals, and the detailed description is omitted. Specifically, description on the operation in processing S100 and S103 is omitted since it is the same as FIG. 5 described in Embodiment 1.

The following describes the operation with focusing on S201 and S202.

In S201, the holding hand detection unit 2632 detects the holding hand (position coordinates of holding hand) by alternately switching between the first sensor unit 200 and the second sensor unit 201 in a certain time period.

Here, an example of the method of detecting a holding hand is described.

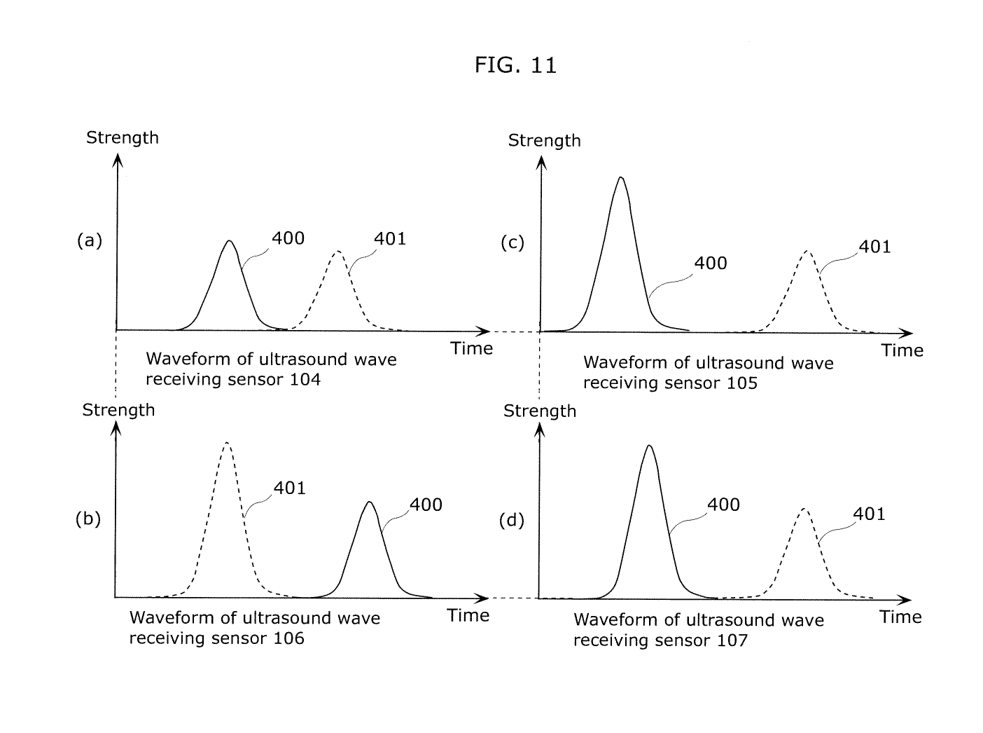

FIG. 10 and FIG. 11 each illustrates an example of the method of detecting a holding hand using the sensor units, performed by the holding hand detection unit 2632 in the present embodiment.

The description below is based on an assumption that, from among the transmitters, for example, the first transmitter 102 repeatedly transmits a pulsed ultrasound wave as a signal, with a certain interval.

FIG. 10 illustrates receiving waveforms (receiving waveform 400 and receiving waveform 401) obtained when the first receiver 104 receives, at different timing (time T1 and time T2, for example), the ultrasound wave transmitted from the first transmitter 102. The origin of each of the graphs shown in FIG. 10 indicates the timing when the first transmitter 102 transmits the pulsed ultrasound wave. In other words, FIG. 10 illustrates a case where the first transmitter 102 transmits the pulsed ultrasound wave in different timing.

As shown in FIG. 10, the peak position of the receiving waveform 400, from among the two receiving waveforms (receiving waveform 400 and receiving waveform 401), has shifted. Therefore, it can be inferred that the receiving waveform 400 is a receiving waveform obtained when the first receiver 104 has received a reflected wave of the ultrasound wave reflected by the finger of the user. This is because it is believed that the finger of the user, that is the target, moves in space near the display unit 261 to perform operations on the information terminal device 260. It is to be noted that the example shown in FIG. 10 is a case where the finger of the user is getting closer to the first receiver 104.

In contrast, the peak position of the receiving waveform 401, from among the two receiving waveforms (receiving waveform 400 and receiving waveform 401), is fixed. Therefore, it can be inferred that the receiving waveform 401 is a receiving waveform obtained when the first receiver 104 has received a reflected wave of the ultrasound wave reflected by the holding hand of the user.

Next, FIG. 11 illustrates receiving waveforms (receiving waveform 400 and receiving waveform 401) obtained when each of the receivers (first receiver 104, second receiver 105, third receiver 106, and fourth receiver 107) receives the ultrasound wave transmitted from the first transmitter 102 at certain timing (time T2, for example). Here, it has already been inferred that: the receiving waveform 400 is the receiving waveform reflected by the finger of the user that is the target for detection; and the receiving waveform 401 is the receiving waveform reflected by the holding hand.

The holding hand detection unit 2632 measures the distance from each of the receivers to the target (holding hand), using (i) transmission time (known) at which a pulsed ultrasound wave is transmitted from the first transmitter 102 and (ii) reception time at which each of the receiving waveform 400 and the receiving waveform 401 is at the peak. Specifically, the holding hand detection unit 2632 detects spatial position coordinates of the target (holding hand) by trilateration based on three distances from among the distances from each of the receivers to the target (holding hand) calculated based on the peak position of the receiving waveform 401 received by the receivers. Here, the finger detection unit 202 may also detect the distance to the target (finger of user), using the same receiving waveform 401. In other words, the finger detection unit 202 may also measure the distance from each of the receivers to the target (finger of user), using (i) transmission time (known) at which the pulsed ultrasound wave is transmitted from the first transmitter 102 and (ii) reception time at which each of the receiving waveform 400 and the receiving waveform 401 is at the peak.

It is to be noted that when the distance to a holder (here, holding hand) for holding the information terminal device 260, in a vertical direction when taking a surface (predetermined surface) of the display unit 261 of the information terminal device 260 as a reference plane, is smaller than or equal to a predetermined threshold, the holding hand detection unit 2632 may further detect the position coordinates of the holder (holding hand) as the position coordinates (held position) of the target (holding hand). In other words, in detection of a holding hand described in FIG. 10, when the spatial position coordinates of the target (holding hand) calculated from the receiving waveform 401 are the spatial position coordinates near the surface of the display unit 261, the holding hand detection unit 2632 may detect the spatial position coordinates of the holding hand using the receiving waveform 401 received by each of the receivers by inferring that the receiving waveform 401 is the receiving waveform reflected by the holding hand.

The description has been provided in the above manner since the advantage is provided especially when the holding hand and the finger of the user are simultaneously detected, however, the present disclosure is not limited to the above. For example, the finger of the user may not present and only the holding hand may present, in space near the display unit 261. In such a case, for example, it may be determined that the detected object is the holding hand simply because the spatial position coordinates do not move longer than or equal to a certain period of time. Furthermore, it may be determined that the detected object is the holding hand simply because the detected spatial position coordinates are spatial position coordinates near the surface of the display unit 261.

As described above, the processing proceeds to S202 after the detection of the spatial position coordinates of the holding hand.

Then, in S202, the sensor selection unit 2030 selects a sensor unit that tends to be least influenced by the holding hand, based on the position coordinates of the holding hand detected by the holding hand detection unit 2632. For example, the sensor selection unit 2030 selects, as the sensor unit that tends to be least influenced by the holding hand, a sensor unit positioned farthest from the position coordinates of the holding hand. In this manner, the sensor selection unit 2030 selects the sensor unit with which detection of the finger of the user is not obstructed by the holding hand.

Next, the finger detection unit 202 actually detects the finger of the user (S104) using the selected sensor unit, and then the processing returns to S100.

In this manner, the information terminal device 260 performs the processing of selecting the sensor unit appropriate for detecting the spatial position coordinates of the finger of the user, as the processing of reducing the influence of the holding hand on the signal (ultrasound wave, for example) transmitted from the transmitter, and detects the finger of the user using the selected sensor unit.

It is to be noted that, in S201, the holding hand detection unit 2632 may store the spatial position coordinates of the detected holding hand into the memory 205, so that the finger detection unit 202 can discern the receiving waveform reflected by the finger of the user from the receiving waveform reflected by the holding hand. In such a case, the finger detection unit 202 can improve the accuracy in detection of the finger of the user, by calculating the difference between (i) the peak of the receiving waveform 401 reflected by the holding hand and (ii) the peak of the receiving waveform 400 actually received, by further using the spatial position coordinates of the holding hand stored in the memory 205.

As described above, with the information terminal device and the control method of the information terminal device in the present embodiment, the spatial position coordinates of the target can be detected regardless of the position of the holder.

Although the above has described the case where the display unit 261 does not have a touch panel portion, the present disclosure is not limited to the above. The display unit 261 may include the touch panel portion in the same manner as in Embodiment 1.

As described above, with the present disclosure, the information terminal device and the control method of the information terminal device can be implemented by which the spatial position coordinates of the target can be detected regardless of the position of the holder.

Thus, it is possible to detect the spatial position coordinates of the finger of the user that is the target, regardless of the position of (i) the holding hand for grasping (holding) the information terminal device or (ii) the putting hand arm put when the user uses the information terminal device on a table or the like, of the user. Accordingly, the user is allowed to operate the information terminal device without paying attention to the position of the sensor unit used for detecting the spatial position coordinates.

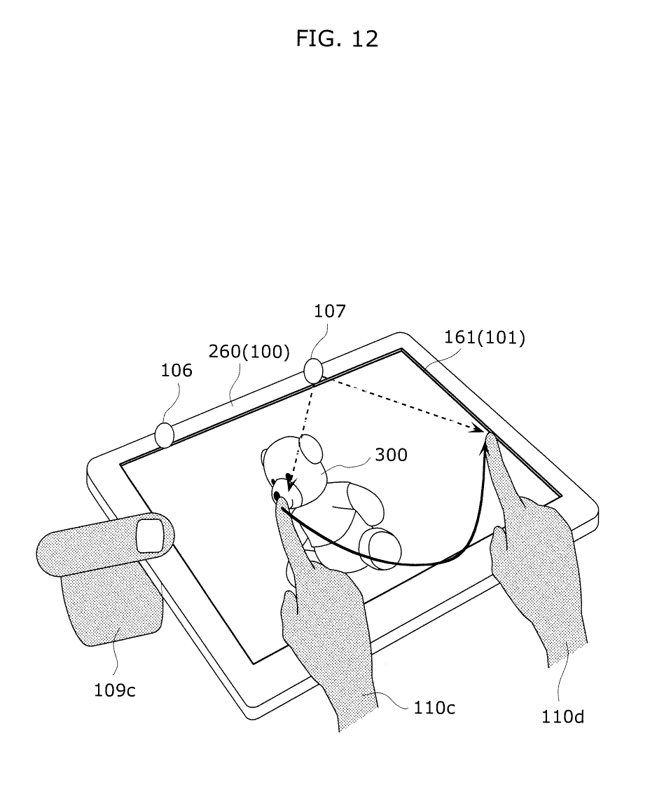

Here, FIG. 12 illustrates an example where the information terminal device according to the present disclosure is used, for example. Even when the user operates the information terminal device by touching, with a finger, a 3D object 300 displayed as if it were being projected from the display screen of the display unit 261 (101) as shown in FIG. 12, the user can operate the information terminal device without paying attention to the position of the sensor unit used for detecting the spatial position coordinates. It is to be noted that FIG. 12 illustrates an example where the user holds the information terminal device 260 (100) with a holding hand 109c and moves the 3D object 300 by an operation to move the 3D object 300 to a position of a finger 110d while touching the 3D object 300 with a finger 110c.

Although the information terminal device and the control method of the information terminal device according to one or plurality of aspects of the present disclosure have been described based on the embodiments, the present disclosure is not limited to the embodiments. Other forms in which various modifications apparent to those skilled in the art are applied to the embodiments, or forms structured by combining constituent elements of different embodiments are included within the scope of the present disclosure, unless such changes and modifications depart from the scope of the present disclosure.

For example, although an example where the sensor units share receivers has been raised in the above description, the present disclosure is not limited to the above. Each of the sensor units may be configured with a transmitter and receivers. In such a case, stopping the sensor unit includes not only stopping all of the transmitter and receivers constituting the sensor unit but also stopping only the transmitter constituting the sensor unit.

Furthermore, for example, although the above description has been provided based on the case where two sensor units (first sensor unit 200 and second sensor unit 201) are available as an example of the sensor units, the present disclosure is not limited to the above. In other words, the number of the sensor units is not limited to two, but greater than or equal to three sensor units may present.

For example, in a case where a large information terminal device is used, these sensor units may be provided at four sides of the information terminal device, and sensor units may be further provided. In such a case, it is sufficient not to use the sensor unit that is close to the holding hand or putting hand arm, that is: to cause the transmitter, which constitutes the sensor unit not used, to stop outputting the signal (ultrasound wave, for example); or not to use the signal, outputted from the transmitter which constitutes the sensor unit not used, for detection of a finger of the user that is the target. The former measure makes it possible to save power consumption, while the latter measure makes it possible to simplify the power source control.

Here, determination may be made on how many sensor unit from among more than or equal to three sensor units should be used, by taking into consideration the distance from the holding hand or putting hand arm to the transmitter which constitutes each of the sensor unit. Alternatively, the determination may be made by taking into consideration a receiving status of the receivers each actually receives the signal outputted from the transmitter which constitutes the sensor unit.

Furthermore, it is also sufficient not to use the at least one receiver that is close to the holding hand or putting hand arm. In other words, it is sufficient not to use the at least one receiver positioned opposite from the transmitter, which constitutes the sensor unit, with the holding hand or holding hand arm therebetween. Here, it is sufficient to: cause the receiver to stop receiving the signal; or not to use the signal, received by the receiver not used, for detection of a finger of the user. The former measure makes it possible to save power consumption, while the latter measure makes it possible to simplify the power source control.

Furthermore, the signal used by the transmitter and the receiver which constitute the plurality of sensor unit is not limited to the ultrasound wave. The signal may be light signal, infrared signal, or infrared LED.

Furthermore, each of the sensor units is not limited to be configured with the transmitter and receiver as described above, and may be a camera. In such a case, it is preferable that the sensor units are more than or equal to three.

Furthermore, although the above description has been provided with taking the holding hand or putting hand arm of the user as an example of the holder for holding the information terminal device, the present disclosure is not limited to the above. The holder may be anything that has certain content and can hold the information terminal device, such as a stand.

Although the above has been described with taking a finger of a user as an example of a target (object for inputting operation) of the spatial position coordinates detection, the present disclosure is not limited to the above. The object for inputting operation may be any object by which operation can be inputted based on the spatial position coordinates, such as a pointing finger, a fist, a pen tip, or a pointer.

It is to be noted that in each of the above non-limiting embodiments, each constituent element may be implemented by being configured with a dedicated hardware or being executed by a software program appropriate for each constituent element. Each constituent element may be implemented by reading and executing the software program recorded on a hard disk or a recording medium such as a semiconductor memory, performed by a program execution unit such as a CPU or a processor. Here, the software which implements an information terminal device or the like in each of the above non-limiting embodiments is a program described below.

That is, the program causes a computer to execute: detecting a held position that is a position of a holder for holding the information terminal device; and selecting, based on the held position detected in the detecting, at least one sensor unit which detects an object from among the sensor units, the object being for inputting operation to at least the information terminal device.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure can be used for an information terminal device and a method of controlling the information terminal device, and particularly can be used with embedded into a mobile information terminal or a spatial position sensing apparatus operable through touch operation or gesture operation, such as a smart phone or a tablet terminal.

1. An information terminal device comprising:
a plurality of sensor units configured to detect an object for inputting operation to at least the information terminal device;
a held position detection unit configured to detect a held position that is a position of a holder for holding the information terminal device; and
a control unit configured to select, based on the held position detected by the held position detection unit, at least one sensor unit which detects the object from among the sensor units.

2. The information terminal device according to claim 1,
wherein the control unit is configured to select, as the at least one sensor unit, a sensor unit positioned farthest from the held position detected by the held position detection unit.

3. The information terminal device according to claim 1,
wherein the control unit is configured to stop operation of a sensor unit positioned closest to the held position detected by the held position detection unit.

4. The information terminal device according to claim 1,
wherein each of the sensor units includes: a transmitter configured to transmit a signal; and a plurality of receivers each configured to receive the signal transmitted from the transmitter.

5. The information terminal device according to claim 2,
wherein each of the sensor units includes: a transmitter configured to transmit a signal; and a plurality of receivers each configured to receive the signal transmitted from the transmitter, and
the control unit is configured to select, as the at least one sensor unit, a sensor unit which includes a transmitter positioned farthest from the held position detected by the held position detection unit.

6. The information terminal device according to claim 3,
wherein each of the sensor units includes: a transmitter configured to transmit a signal; and a plurality of receivers each configured to receive the signal transmitted from the transmitter, and
the control unit is configured to stop operation of a sensor unit including a transmitter positioned closest to the held position detected by the held position detection unit.

7. The information terminal device according to claim 6,
wherein the control unit is configured to stop, as operation of the sensor unit positioned closest to the held position, operation of only the transmitter positioned closest to the held position detected by the held position detection unit.

8. The information terminal device according to claim 4,
wherein the receivers are common to and shared by each of the sensor units.

9. The information terminal device according to claim 1, further comprising
an object detection unit configured to detect the object, using the at least one sensor unit from among the sensor units selected by the control unit.

10. The information terminal device according to claim 1,
wherein the sensor units are further configured to detect a position that is a position of a holder for holding the information terminal device, and
the held position detection unit is configured to detect the held position using the sensor units.

11. The information terminal device according to claim 1,
wherein the held position detection unit is configured to detect, as the held position, a position of the holder for holding the information terminal device, when a distance to the holder from a display screen of the information terminal device is less than or equal to a threshold.

12. A method of controlling an information terminal device, the method comprising:
detecting a held position that is a position of a holder for holding the information terminal device; and
selecting, based on the held position detected in the detecting, at least one sensor unit which detects an object from among the sensor units, the object being for inputting operation to at least the information terminal device.

13. A non-transitory computer-readable recording medium having recorded thereon a computer program for causing a computer to control an information terminal device, the program causing the computer to execute:
detecting a held position that is a position of a holder for holding the information terminal device; and
selecting, based on the held position detected in the detecting, at least one sensor unit which detects an object from among the sensor units, the object being for inputting operation to at least the information terminal device.

14. An information terminal device comprising:
a plurality of sensor units configured to detect an object for inputting operation to at least the information terminal device;
a held position detection unit configured to detect a held position that is a position of a holder for holding the information terminal device;
a control unit configured to select, based on the held position detected by the held position detection unit, at least one sensor unit which detects the object from among the sensor units; and
an object detection unit configured to detect the object, using the at least one sensor unit from among the sensor units selected by the control unit.

15. An information terminal device comprising:
a plurality of sensor units configured to detect an object for inputting operation to at least the information terminal device;
a held position detection unit configured to detect, using the sensor units, a held position that is a position of a holder for holding the information terminal device;
a control unit configured to select, based on the held position detected by the held position detection unit, at least one sensor unit which detects the object from among the sensor units; and
an object detection unit configured to detect the object, using the at least one sensor unit from among the sensor units selected by the control unit.
